(19) United States
(12) Patent Application Publication
(10) Pub. No.: US 2009/0327292 A1
(43) Pub. Date: Dec. 31, 2009

(54) ENSURING CONSISTENCY AMONG SHARED COPIES OF A DATA ELEMENT

(75) Inventors: Craig A. Janssen, St. Charles, IL (US); Michael D. Pearce, Barrington, IL (US); Nitya Narasimhan, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/487,159

(22) Filed: Jun. 18, 2009

Related U.S. Application Data
(60) Provisional application No. 61/076,296, filed on Jun. 27, 2008.

(51) Int. Cl. G06F 17/30; G06F 15/16

(52) U.S. Cl. 707/8; 707/203; 707/E17.005; 709/203; 707/E17.007

(57) ABSTRACT

Disclosed is a “light weight” protocol used to coordinate shared copies of a data element. A central repository holds a master copy of the data element. Applications “subscribe” to the data element (or to an aspect of it) by sending a message to the central repository. Whenever the data element (or aspect) is changed, applications that have subscribed to the data element (or aspect) are notified of the change. When an application wishes to change the value of a subscribed aspect, it sends an update request to the central repository. The central repository changes the master copy of the data aspect to the requested value and then informs all subscribed applications of the new data value. If two applications both wish to change the value of the same data aspect, they send their update requests, and the central repository processes them in the order in which they are received.

### FIELD OF THE INVENTION

The present invention is related generally to distributed computing environments and, more particularly, to ensuring data consistency in such environments.

### BACKGROUND OF THE INVENTION

Computer applications are becoming ever more complex and dependent upon communications with other applications. (In this context, the word “application” is meant broadly to include user applications, operating systems, and utilities.) Often, communications among applications are coordinated by sharing data values. All of the participating applications know the data values, and, if any participating application changes a data value, then all of the other applications are made aware of the change.

Protocols exist for ensuring the consistency of data values shared by, and possibly changed by, numerous participating applications. Sometimes, a central data repository “owns” the data, and any interested application must ask the central repository for the current value. Changes to the data values are coordinated by messages sent to and from the central repository. These protocols ensure “hard” consistency of the data, but they can involve a huge amount of messaging to coordinate the participating applications. This coordination traffic can sometimes be a processing and memory-bandwidth burden when the participating applications are all running on a single computing device, and the potential problems only grow when the participating applications are running on a distributed set of computing devices.

Locally connected devices (e.g., computing devices on a wired LAN) can often handle the required messaging traffic, but such traffic can overwhelm small, portable devices by using up too processing power, too much data bandwidth, and thus too much battery power.

### BRIEF SUMMARY

The above considerations, and others, are addressed by the present invention, which can be understood by referring to the specification, drawings, and claims. According to aspects of the present invention, a “light weight” protocol is used to coordinate shared copies of a data element. A central repository holds a master copy of the data element. Applications (either on the same computing device as the central repository or on other devices) “subscribe” to the data element (or to an aspect of it) by sending a message to the central repository. Whenever the data element (or data aspect) is changed, applications that have subscribed to the data element (or data aspect) are notified of the change. Because an application may choose to subscribe to only an aspect of the data element rather than to the full data element, the application is spared from receiving update notifications when other (non-subscribed to) aspects of the data element change.

When an application subscribes to an aspect of a data element, the application receives from the central repository the current value of that aspect. When an application wishes to change the value of a subscribed aspect, it sends an update request to the central repository. The central repository accepts the request, changes the master copy of the data aspect to the requested value, and then informs all subscribed applications of the new data value. If two applications both wish to change the value of the same data aspect, they send their update requests, and the central repository accepts both requests, processing them in the order in which they are received. Thus, conflicts are resolved by a straightforward “last updater wins” method that requires no elaborate coordination mechanism. This extremely powerful technique significantly reduces data traffic when compared with previous methods that require a great deal of data-coordination messaging.

In some embodiments, the central repository, upon receiving two nearly simultaneous update requests, only responds to the second one. The result is the same as in the simpler method described above (“last updater wins”), but this refinement can reduce message traffic.

To help applications coordinate their changes, a timestamp can be attached to each notification message stating when the aspect of the data element was changed. However, the protocol does not require any coordination of timers among the applications. The notification message may also state which application requested the most recent change.

In some embodiments, the central repository sends out values for the entire data element to all subscribers whenever any aspect of the data element is changed. This is useful when the data element is relatively small. In some embodiments, all subscribing applications receive notifications with a timestamp whenever any aspect, even an unsubscribed aspect, of a subscribed data element changes.

In some situations, an application may need to “LOCK” a data aspect for a time so that the data aspect cannot be changed by any other application. The above method can be used without change for this. A LOCK field is associated with the data aspect. To lock the aspect, a first application waits until the value of the LOCK field is UNLOCKED. Then the first application requests that the value of the LOCK field be changed to LOCKED. If the update notification indicates that the new value of the LOCK field is LOCKED, and if the update notification states that the first application requested this change, then the first application has locked the data aspect and may proceed. If, on the other hand, the field was locked by another application, then the first application waits until the other application releases it (by requesting that the value be changed to UNLOCKED). This extremely powerful lock/unlock protocol requires no special refereeing by the central repository.

In some embodiments, the central repository tracks the subscriptions to a data element. For some data elements, when the number of subscriptions drops to zero, the central repository deletes the data element.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIGS. 2a and 2b together form a flowchart of an exemplary method on a client for updating a data aspect;

FIGS. 3a and 3b together form a flowchart of an exemplary method on a central repository for updating a data aspect; and

FIGS. 4a and 4b together form a flowchart of an exemplary method on a client for locking a data aspect.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

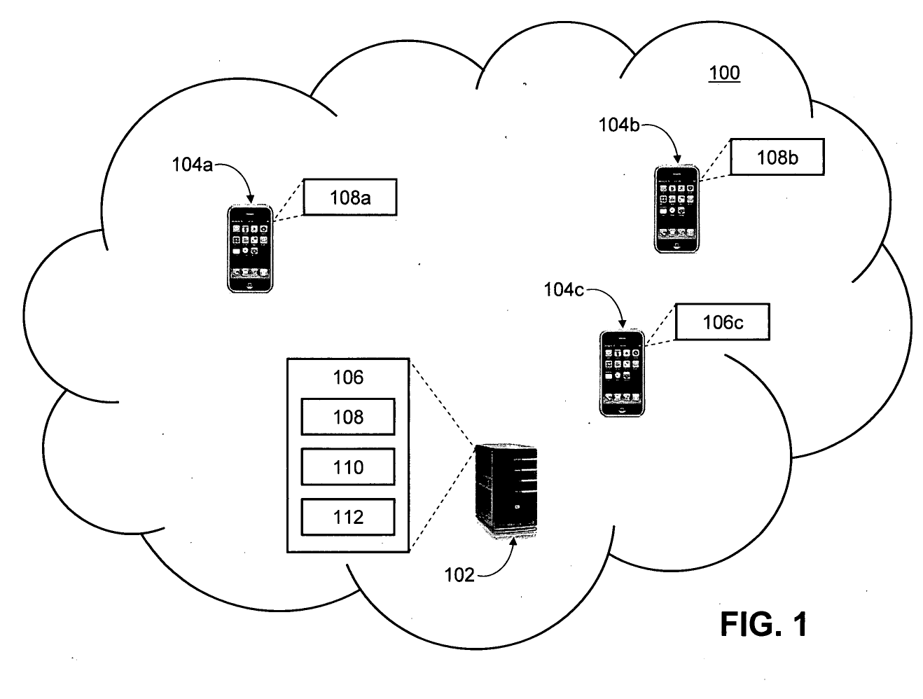

FIG. 1 introduces the players and concepts of the present invention. The communications environment 100 is depicted as the usual “network cloud” that supports messaging among a central repository 102 and any number of applications 104a, 104b, and 104c. Note that the central repository 102 and the applications 104a, 104b, and 104c are actually software entities and can be any combination of user applications, operating systems, and utilities.

FIG. 1 depicts a typical scenario where the central repository 102 is hosted on a compute server and the applications 104a, 104b, and 104c are hosted on personal communications devices (e.g., cell phones, personal digital assistants, or personal computers) that wirelessly communicate with the central repository 102. While aspects of the present invention can beneficially support this scenario, other scenarios are contemplated. For example, aspects of the present invention may also be practiced when one or more of the client applications 104a, 104b, and 104c are running in separate address spaces on the same computing device that hosts the central repository 102. As another example, the central repository 102 can be running as a utility on one or more of the personal communications devices hosting the applications 104a, 104b, and 104c.

The central repository 102 hosts a master copy of a data element 106. The phrase “data element” is used to convey in the most general way any data structure or combination of data structures. A data element can be a single bit value, a list of values, a spreadsheet, a data object, an elaborate database with millions of entries of different types and values, or a combination of these data structures along with any associations among them. The data element 106 need not be physically stored on the host of the central repository 102 itself (though that is the typical scenario) as long as the central repository 102 has some measure of access to, and control of, the data element 106.

The exemplary data element 106 of FIG. 1 is shown in association with three “data aspects” 108, 110, and 112 of the data element 106. Here again, the phrase “data aspect” is used most generally. Commonly, the data aspect 108 is a sub-field of the data element 106. A data aspect can also be identical to the data element itself. (This useful shorthand is used below to avoid repeating “the data aspect or data element” interminably.) Other data aspects can represent associations of the data element 106 with other data elements, such as inheritance, ownership, or other relations known from the object-oriented realm. Some data aspects represent information about a data element even though they are not strictly contained as sub-fields within the data element such as events in the history of the data element (e.g., creation, modification, deletion), the name of the data element's author or owner, a timestamp of the data element's most recent change, its update history, or a list of associated applications. Some of these concepts are discussed in the examples below. All of these concepts, and others, are well known in the field of computer data management, and all are contemplated here.

The applications 104a and 104b have each subscribed to the data aspect 108. Upon subscription, they each received from the central repository 102 a copy (108a and 108b, respectively) of the data aspect 108. The application 104c has subscribed to the entire data element 106, and its local copy 106c includes, of course, a copy (not shown) of the data aspect 108. Any of the three applications 104a, 104b, and 104c can update the data aspect 108, and whenever the data aspect 108 is updated, all three applications 104a, 104b, and 104c receive notifications of that fact.

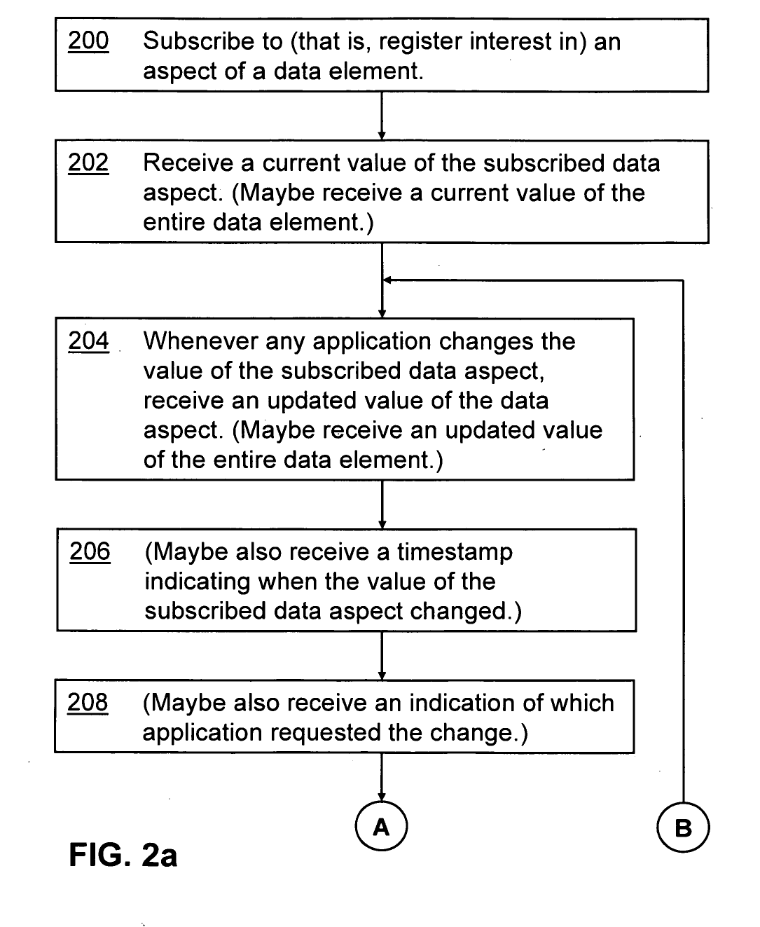

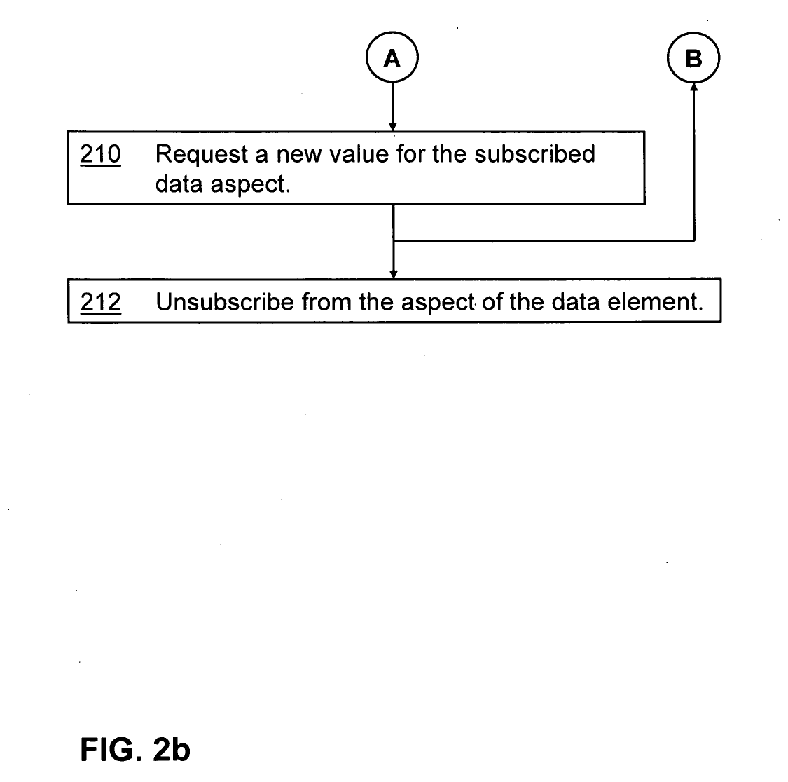

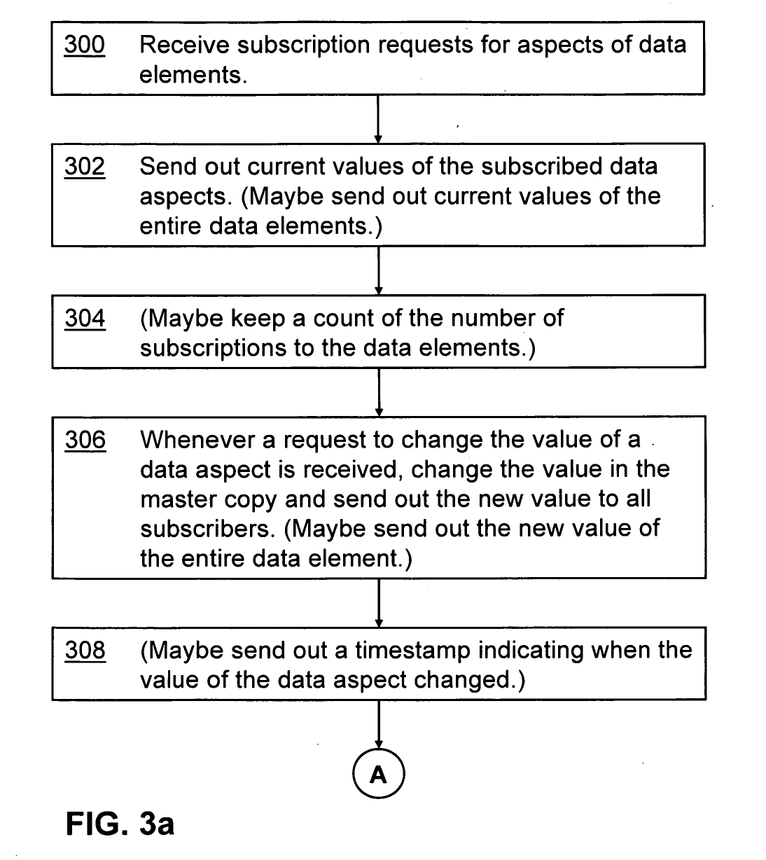

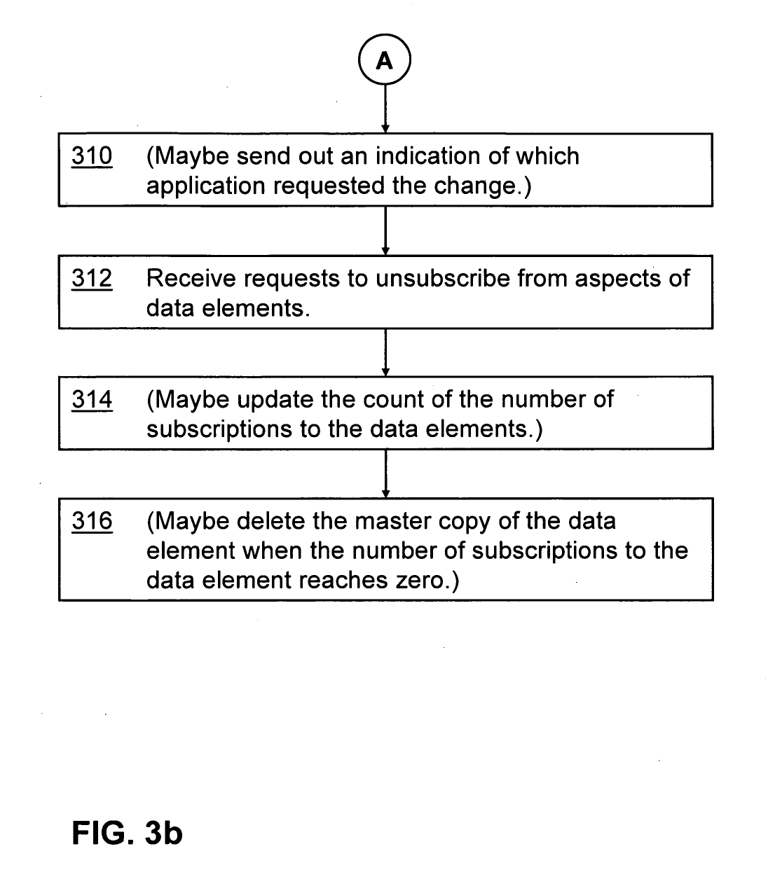

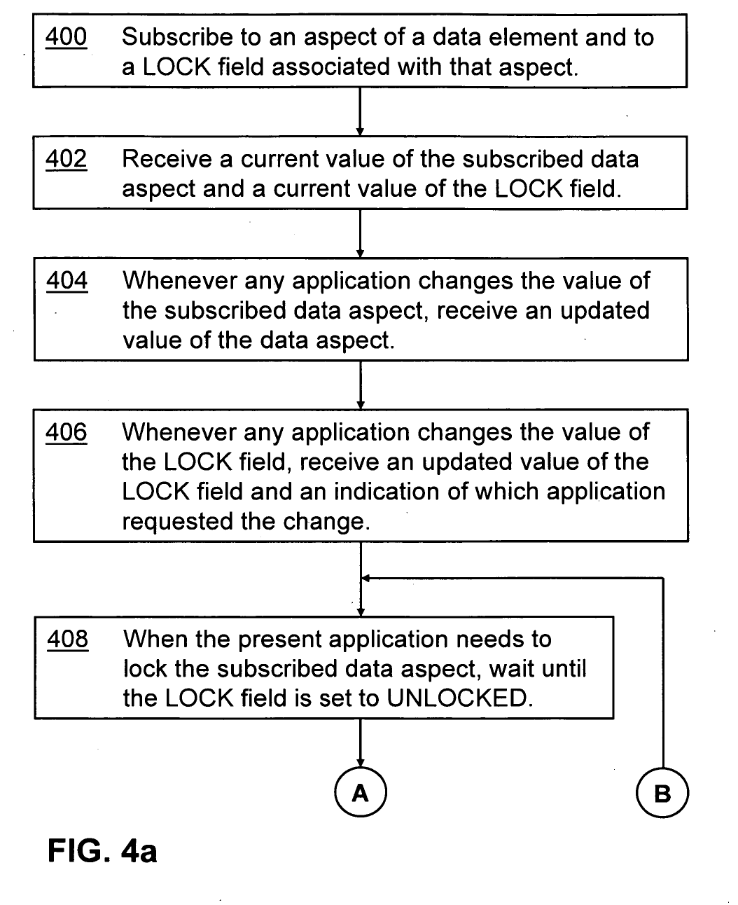

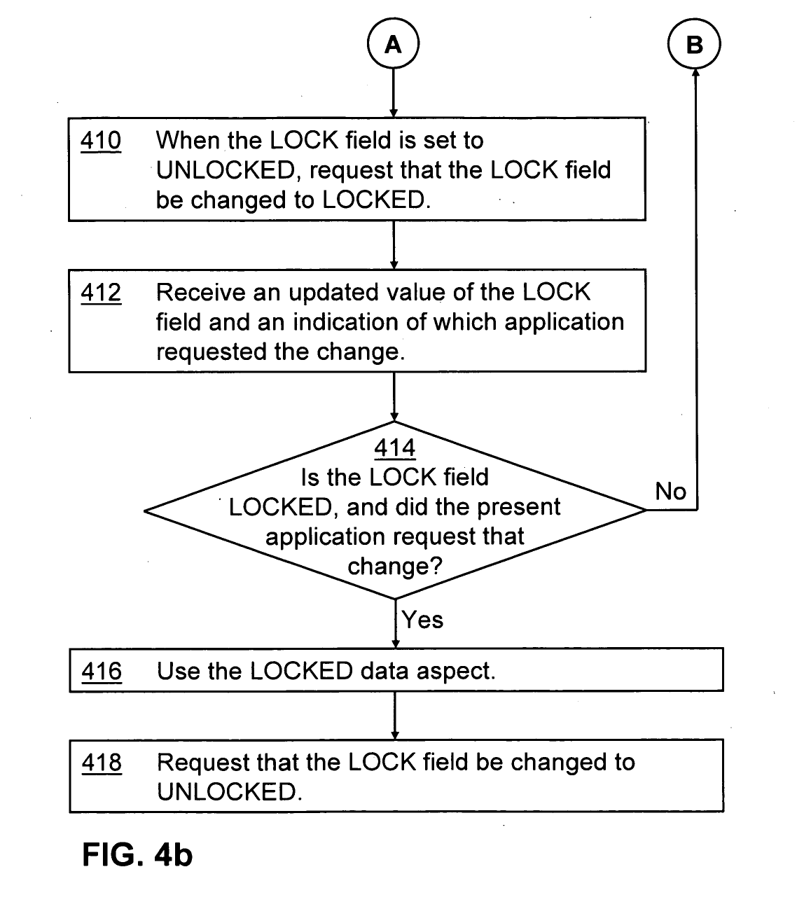

An exemplary method for updating a subscribed data aspect is shown in FIGS. 2 and 3. The method of FIGS. 2a and 2b is performed by the applications 104a, 104b, and 104c, while the central repository 102 performs the method of FIGS. 3a and 3b. These figures are discussed together. To prevent details of messaging and data structures from confusing the presentation of overall concepts, these details are omitted from the present discussion. An exemplary embodiment containing all of these details is presented below, after the discussion which accompanies FIG. 4.

In step 200 of FIG. 2a, the application 104a subscribes to the data element 108. (The shorthand noted in the discussion of FIG. 1 is applied here, and the “data aspect” can be the entire data element, a sub-field of the data element, multiple data elements, or any information associated with one or more fields or data elements.) The subscription request is received by the central repository 102 in step 300 of FIG. 3a.

Assuming that the subscription request is in order (e.g., the requested data aspect 108 is known to the central repository 102, the requesting application 104a has sufficient privileges to subscribe to this data aspect 108), the central repository 102 accesses its master copy of the data element 106, retrieves a copy of the requested data aspect 108, and sends that copy to the requesting application 104a in step 302 of FIG. 3a. Note that in some situations (e.g., when the data element 106 is relatively small), it is more convenient to send a copy of an entire data element even when only a sub-field is requested. The copy of the requested data aspect 108 is received in step 202 of FIG. 2 and is stored as the local copy 108a.

Strictly speaking, step 304 of FIG. 3a is optional. In this step, the central repository 102 keeps track of the number of subscriptions to a data element or to aspects of a data element. This count is useful in garbage collection, as discussed below in reference to step 316 of FIG. 3b.

Before considering the procedure used by the application 104a to change the value of the data aspect 108, consider what the application 104a does when the other applications 104b and 104c subscribing to the data aspect 108 change its value. Whenever the value is changed, all subscribing applications (including the application requesting the change) receive a notification of the new value in step 204.

As with the response to the original subscription request, the notification in step 204 may include the value of an entire data element even though only a portion of it has changed. Thus in some embodiments, the application 104a receives a new copy of the entire data element 106 even though the subscribed data aspect 108 has not been changed because, for example, the data aspect 110 was changed by the application 104c.

Step 206 of FIG. 2a and the corresponding step 308 of FIG. 3a are optional. In some embodiments, the notification of a value change includes a timestamp indicating when the value changed. This can be useful in many ways. For one example, an application may subscribe to only this timestamp of a data element. Then whenever the data element changes, the application is notified, and, if it is interested, the application can query the central repository 102 for more information about the change. While this timestamp information may sometimes be useful, the methods of the present invention are not dependent upon any careful clock synchronization among the central repository 102 and the client applications 104a, 104b, and 104c.

Step 208 of FIG. 2a and the corresponding step 310 of FIG. 3b are also optional in some embodiments. The central repository 102 can include an indication of which application requested the change indicated in the change notification. The simple protocol that some embodiments use to LOCK a data aspect, discussed below in relation to FIG. 4, relies upon this information.

When the application 104a wishes to change the value of the data aspect 108, it sends a request with the desired new value to the central repository 102 (step 210 of FIG. 2b). The request is received in step 306 of FIG. 3a. The central repository 102 updates the master copy of the data aspect 108 and sends out the update notifications to all applications 104a, 104b, and 104c that subscribed to the data aspect 108. (As already discussed, the change notification may include the entire data element 106, may include a timestamp, and may indicate that the change was requested by the application 104a.)

Note what the central repository 102 does not do: It does not consider whether or not to apply the requested change. All change requests that are in order (as described above for the subscription requests) are accepted and applied. When two applications make nearly simultaneous changes, there is no special processing to handle this “race” condition: The changes are simply accepted and processed in the order in which they are received by the central repository 102. Thus, this simple protocol supports a “last updater wins” protocol. Because of this, whenever the application 104a requests a change, it should consult the update messages (received in step 204 of FIG. 2a) to see if its request actually “stuck.” If not, and if it is important, it is up to the application 104a to make another request. (The LOCK protocol discussed below in relation to FIG. 4 can be used when it is important that the requested change “stick.”)

Some embodiments of the central repository 102 refine the processing of step 306 slightly. If two change requests for the same data aspect are received nearly simultaneously, the central repository 102 may choose to simply discard the first one and apply the second. The end result is the same (“last updater wins”), and this refinement saves the cost of sending out the first update notification (which would be almost immediately overridden by the second one anyway).

When the application 104a is finished using the subscribed data aspect 108, it may inform the central repository 102 of that fact by unsubscribing in step 212 of FIG. 2b. The central repository 102 receives the unsubcription request in step 312 of FIG. 3b and may optionally use that information in step 314 to decrement the count of the subscribers to the data element 106. In some embodiments, and for some data elements, when the number of subscribers drops to zero, the central repository 102 deletes the master copy of that data element in step 316. Of course, some data elements may persist on the central repository 102 even when no applications are currently subscribed to it.

There are some situations for which the simple “last updater wins” protocol is inadequate. For example, consider the situation where the subscribed data aspect 108 is a counter that should be incremented whenever one of subscribing applications 104a, 104b, and 104c does “something relevant.” Assume that the current value of the data aspect 108 is 3. If both applications 104a and 104b do “something relevant” nearly simultaneously, they will each see the current value of 3 and send an update request to change that value to 4. The central repository 102 accepts both requests, applies them, and changes the value to 4. This is, of course, incorrect, as the value should now be 5.

One solution to this problem is to increase the complexity of the protocol described in relation to FIGS. 2 and 3. In addition to the “change value” request, the protocol could support an “increment value” request. In the situation described above, the central repository 102 would receive two increment value requests, apply both, and change the value to 5. While this solution works in this simple example, more situations can be imagined which would require more kinds of requests, and the protocol could become unmanageably complex.

A simpler solution is preferred. A LOCK protocol, based entirely on the “last updater wins” protocol, is provided that allows the subscribing application 104a to modify the value of the data aspect 108 without interference from the other subscribing applications 104b and 104c. That is, the application 104a ensures that its change “sticks.” The application-side of the LOCK protocol is illustrated in FIG. 4. In step 400 of FIG. 4a, the application 104a subscribes to the data aspect 108 as before. It also subscribes to a LOCK field (e.g., field 110 in FIG. 1) associated with that data aspect 108. The LOCK field 110 may be a binary field whose value can only be LOCKED or UNLOCKED. In a preferred embodiment, the central repository 102 treats the LOCK field 110 just as it treats any other data aspect. The central repository 102 follows the method illustrated in FIG. 3 and may not even be aware that it is participating in the LOCK protocol. In step 400, the other applications 104b and 104c may also subscribe to the data aspect 108 and to the associated LOCK field 110.

Just as in the protocol illustrated in FIG. 2, the application 104a receives, in step 402, the current values (from the master copy 106) of the subscribed data aspect 108 and of the associated LOCK field 110. Also just as before, the application 104a is notified (step 404) whenever the data aspect 108 is changed.

The data application 104a also receives notifications whenever the associated LOCK field 110 changes (step 406). In FIG. 2a, it is optional to include an indication of which application requested the change (step 208), but in the LOCK protocol of FIG. 4, this indication is very important (step 406).

When the application 104a needs to lock the data aspect 108, it waits until the associated LOCK field 110 has the value UNLOCKED (step 408). When the LOCK field 110 has the value UNLOCKED, the application 104a requests that the LOCK field 110 be changed to LOCKED (step 410 of FIG. 4b). In step 412, the application 104a receives the update notification indicating both the value of the LOCK field 110 and which application requested the most recent change.

Step 414 is the key to the LOCK protocol. Only if the received value of the LOCK field 110 is LOCKED and if the application 104a is indicated as the application that requested that change, then the application 104a has successfully locked the data aspect 108 for its own use. If either test fails, then the application 104a returns to step 408 of FIG. 4a to try again.

Step 414 is key because the central repository 102 does not referee the LOCK protocol of FIG. 4, just as it does not referee the update protocol of FIGS. 2 and 3. As noted above, the central repository 102 may not even know that there is such a thing as a LOCK protocol. It simply accepts all changes and sends out notifications. While it is possible to make the central repository 102 referee a LOCK protocol by applying special rules (e.g., only accept a request to set a LOCKED value if the current value is UNLOCKED, only accept a request to set an UNLOCKED value from the application that most recently set the value to LOCKED), it is preferred to leave the refereeing to the good conduct of the subscribing applications themselves and thus to reduce the processing load on the central repository 102 as much as possible.

If both tests in step 414 succeed, then the application 104a has control of the data aspect 108 and may use it as necessary in step 416 without interference from the other subscribing applications 104b and 104c. When it is finished, the application 104a unlocks the data aspect 108 by requesting that the LOCK field 110 be set to UNLOCKED (step 418).

The above discussion illustrates the concepts of the present invention without a clutter of implementation details. Having only the above discussion, one of ordinary skill in the art could implement aspects of the present invention in any of a number of embodiments. However, it may be useful to consider in detail one embodiment of an implementation protocol. The following discussion presents such an embodiment called the “Remote AppBus Protocol.” The following discussion is not meant to limit the scope of the claims in any manner.

### Introduction to the Remote AppBus Protocol

The Remote AppBus Protocol consists of a collection of disjoint request-response messages that can be broadly grouped into Framework and DataObject (“DO”) categories. The Framework requests support connection setup (with user authentication for session), callback registration/removal (for data insertion events), queries (using predicates), data object creation (and insertion) and data cache maintenance (used by Remote AppBus enablers, not by applications). The DataObject requests primarily support accessor and modifier methods related to the attributes, associations, and payload for each object, as well as callback registration/removal for data modification events.

To stay lightweight and to reduce chatter, Remote AppBus enforces a one-response-per-request rule. The response messages themselves are quite straightforward. Most requests receive positive/negative acknowledgments. A small subset however return richer “results” data. For example:
A Framework request to create a new data object returns an ID for the DataObject instance and allows the core AppBus to maintain and to index unique IDs for each stored data item.
A DataObject request to update the “timestamp” of that data will return a new timestamp created by the core AppBus (e.g., the central repository). This avoids clock synchronization problems and simplifies garbage collection (by local timestamp) at the core AppBus.

In addition, Remote AppBus supports a limited set of error messages that cover the most frequent exceptions.

While requests are initiated by the remote endpoint (e.g., an application), there also exist asynchronous notification messages initiated by the core AppBus for delivery to the remote endpoint. These respond to previous Framework or DataObject event subscription requests from that remote endpoint. Such subscriptions can be initiated by an application (explicit) but may also be initiated by the remote infrastructure (implicit) as a way of performing proactive synchronization of data items that are in its cache. For the latter, some notifications (e.g., timestamp updates for associated data objects) are targeted for implicit consumption only (to maintain data consistency) and are not delivered to explicit subscribers. To reduce chatter, notifications do not trigger acknowledgements.

While the protocol elements described so far are pretty straightforward, a novelty of the present approach is the use of an on-demand caching strategy at the remote end which provides the desired illusion of consistency but without the huge messaging overheads associated with strict RPC or data mirroring solutions that demand strong data consistency. The present approach involves a multi-faceted, write-through coherent caching system that prioritizes consistency only of relevant data required for immediate access on the remote endpoint. Thus, only those DataObject instances that are “referenced” (either in a query result or in an event notification) are cached by the infrastructure on the remote side. More importantly, only significant parts of the data are cached, where significance is related to the aspects of the data that were requested when that instance was referenced. Each part of a DO instance can be transferred and cached on-demand as follows:

Reference Only: A “stub” DataObject can be created on the remote endpoint and populated only with a DataObject identifier and a current DateStamp. References are created in response to receiving a query result (a list of DO references), as a part of the association list within a more complete DO in the cache, or as a DO reference in an event notification. If the application never queries a DO reference further, then that data object is never fully populated, and no extra bandwidth is consumed in keeping those “unknown” details consistent.

Attributes: DO attributes are represented by name-value pairs. If an application attempts to view or to update attributes for a DO, then all attributes for that DO are instantly fetched to update the cached item. The tradeoff is between the initial delay in populating DO attributes vs. less cost in subsequent accesses. This supports the observation that an application that expresses an interest in a DO (by viewing one attribute) will likely turn around and interact with more attributes. The populating of all DO attributes is triggered by a single response to the first view/update attribute request.

Payload: The DO payload is simply a “blob” (byte-array) with mandatory attributes indicating size and content type (currently defined by a MIME-type). Payload blobs can be arbitrarily large and are potentially useless to applications that do not understand, or have an interest in, that content type. Thus, payloads are not automatically populated in cached DataObjects unless explicitly requested by the application.

Association List: This is a list of “child DO” references maintained by a data object when applications associate it with another data item in a parent-child relationship. The present approach supports a flat hierarchy (a DO can be a parent or a child, but not both), though multiple associations can exist (parents can have many children, and a child can have many parents). Because lists can be large, DO “references” are maintained only if an association list is requested.

Finally, once any part of a DO is cached, it is then kept in synchrony with its DO counterpart on the core AppBus by using the event notification mechanism. For every DO reference dispatched to a remote endpoint, the local endpoint registers itself for DO modification events and dispatches these to the remote DO as they occur. The remote endpoint then uses these notifications to keep the partially cached DO consistent. Note that by exploiting notifications, the present approach essentially ensures that the core AppBus is unaware of the remote mirroring of the selected DO.

A more complex aspect of Remote AppBus involves the simultaneous garbage collection of data on local and remote endpoints. If a DO is referenced and in use on the remote side, then the local side must “pin” that DO reference in the core AppBus to ensure that it is not inadvertently garbage collected. This holds for every DO reference sent to the remote side (in queries, notifications, or association lists). However, many of these DO references will eventually be unused on the remote side and will be de-referenced there. Because “pinned” DOs impact the memory usage on the core AppBus (e.g., on a mobile device), it is critical that the remote endpoint promptly notify the core of “unused” references so they can be unpinned on the local side. This is achieved using a timer on the remote endpoint which periodically triggers a cache evaluation that prunes any unused references and posts that list back to the core AppBus.

### Theory of Operation

The two entities that take part in a Remote AppBus (“RAP”) connection are the Remote AppBus Client (“RC”) and the Remote AppBus Adapter (“RA”) that acts as a client proxy. The RA resides on the same device as the AppBus framework, and the RC resides on the other side of the RAP connection. The RC can make queries for AppBus data and events, create new AppBus data, and modify existing AppBus data. These activity requests are transmitted across the Remote AppBus connection to the RA. The RA then handles the AppBus framework interactions on behalf of the RC and transmits the results across the link.

### Connection Management

Remote AppBus enables remote access to the AppBus framework from two kinds of remote clients: remote processes running on the same device but in a separate address space and remote processes running on a different device that can communicate with the AppBus framework over some wired or wireless link (e.g., Bluetooth). In the latter case, RAP relies on Bluetooth Serial Port Profile connections to carry messages. These connections are established by the RAP Client and are maintained as long as the client maintains connection to the AppBus framework.

### Authentication

There are two security modes for a normal, local AppBus client to connect to the AppBus framework, and this applies to remote clients as well. These modes are secure and public.

### Message Framing and Encoding

Boolean data are encoded as a single byte having either a 0x00 (false) or 0x01 (true) value. Integer data are encoded in big-endian variable length fields, depending on the maximum range of values allowed for the field in question. Integer field lengths are 1, 2, 4, or 8 bytes long. Integers are unsigned unless otherwise indicated. String data are encoded using a 2-byte (big-endian) length prefix followed by the specified number of bytes of UTF8-encoded character data. (Note: The length prefix specifies the number of bytes of character data, not the number of characters in the string.) The longest string that may be transferred using this encoding is 65535 characters, assuming that none of the characters requires more than one byte. Note that this encoding scheme is based on IETF standard network byte ordering and is compatible with the commonly used java.io.DataInputStream and java.io.DataOutputStream classes.

### Framing

Each message is framed using a length-prefix scheme. The 8 bytes of message framing fields are not included in the message size, allowing a maximum enclosed message size of 65535 bytes. High-level messages may be fragmented into multiple low-level frames, allowing arbitrarily large high-level messages. The final fragment of a high-level message should have the FLAG_FINAL field set to true (0x01), other fragments should have the FLAG_FINAL field set to false (0x00). All fragments of a high-level message MUST have the same MSG_SEQ value. For each high-level MSG, there must be one high-level RPY (which may be similarly fragmented into multiple low-level frames). The MSG_SEQ field of the RPY must match the MSG_SEQ of the corresponding MSG. LRDMP Clients and Servers generate MSG sequence numbers independently of each other.

There may be a single-frame error message that indicates an error in processing the original message. When an error message is sent, there will be no reply message.

Messages are processed in order by each peer.

The format of the enclosed messages (MSG, RPY, or ERR) is message-type specific.

In the following message descriptions, all lengths are in bytes unless otherwise indicated.

Framing Header:

| Field | Type | Length | Value | Description |
|---|---|---|---|---|
| SYNC | Integer | 2 | 0xBEAD | Sync Pattern |
| TYPE | Integer | 1 | 0-255 | Message Type: |
| | | | | 0x00: MSG |
| | | | | 0x01: RPY |
| | | | | 0x02: ERR |
| FLAG_FINAL | Boolean | 1 | 0x00, 0x01 | Final Fragment Flag |
| MSG_SEQ | Integer | 2 | 0-65535 | Message Sequence |
| | | | | Number |
| MSG_LEN | Integer | 2 | 0-65535 | Message Length |

### Attribute Data Type Parsing

Currently, attributes may have the data types String, Date, and Integer. Regardless of type, however, they are transmitted across the Remote AppBus Protocol as String data. Therefore, standards for acceptable data representation in the String format should be established. For Integer data, numerical digits (0-9) may be used. A leading + or − may be included to indicate positive and negative values respectively. The leading + is assumed if no sign indicator is included. For Date data, the format supported is YYYYMMDD HH:MI:SS:MS.

### Messages

MSG: All message exchanges begin with an MSG message. All MSG messages begin with a 1-byte message header that indicates the type of message. The rest of the message is formatted according to the message type.

MSG Header:

| Field | Type | Length | Value: Description |
|---|---|---|---|
| MSG_TYPE | Integer | 1 | MSG Type: |
| | | | 0x00: MSG_AB_CONNECT |
| | | | 0x01: MSG_AB_DISCONNECT |
| | | | 0x02: MSG_AB_SUBSCRIBE |
| | | | 0x03: MSG_AB_UNSUBSCRIBE |
| | | | 0x04: MSG_AB_NOTIFY |
| | | | 0x05: MSG_AB_QUERY |
| | | | 0x06: MSG_AB_CREATE_DO |
| | | | 0x07: MSG_AB_ADD_DO |
| | | | 0x08: MSG_AB_REMOVE_REFS |
| | | | 0x09: MSG_DO_SUBSCRIBE |
| | | | 0x0A: MSG_DO_UNSUBSCRIBE |
| | | | 0x0B: MSG_DO_NOTIFY_UPD_ATT |
| | | | 0x0C: MSG_DO_NOTIFY_UPD_PAYLOAD |
| | | | 0x0D: MSG_DO_NOTIFY_UPD_TSTAMP |
| | | | 0x0E: MSG_DO_NOTIFY_ADD_CHILD |
| | | | 0x0F: MSG_DO_NOTIFY_ADD_PARENT |
| | | | 0x10: MSG_DO_NOTIFY_REM_ATT |
| | | | 0x11: MSG_DO_NOTIFY_REM_PAYLOAD |
| | | | 0x12: MSG_DO_NOTIFY_REM_CHILD |
| | | | 0x13: MSG_DO_NOTIFY_REM_PARENT |
| | | | 0x14: MSG_DO_NOTIFY_ATTACHED |
| | | | 0x15: MSG_DO_REQ_ATTRIBUTES |
| | | | 0x16: MSG_DO_REQ_PAYLOAD |
| | | | 0x17: MSG_DO_REQ_GET_PARENTS |
| | | | 0x18: MSG_DO_REQ_GET_CHILDREN |
| | | | 0x19: MSG_DO_UPDATE_ATTRIBUTES |
| | | | 0x1A: MSG_DO_UPDATE_PAYLOAD |
| | | | 0x1B: MSG_DO_UPDATE_TIMESTAMP |
| | | | 0x1C: MSG_DO_ADD_CHILD |
| | | | 0x1D: MSG_DO_REMOVE_ATTRIBUTES |
| | | | 0x1E: MSG_DO_REMOVE_PAYLOAD |
| | | | 0x1F: MSG_DO_REMOVE_CHILDREN |
| | | | 0x20: MSG_DO_REMOVE_ALL_CHILDREN |

RPY: All successful message exchanges terminate with an RPY message. All RPY messages begin with a 1-byte message header that indicates the type of the message. The rest of the message is formatted according to the reply type.

RPY Header:

| Field | Type | Length | Value: Description |
|---|---|---|---|
| RPY_TYPE | Integer | 1 | RPY Type: |
| | | | 0x00: RPY_POSITIVE_ACK |
| | | | 0x01: |
| | | | RPY_APP_CONNECTION_CRED |
| | | | 0x02: RPY_DO_ID_LIST |
| | | | 0x03: RPY_DO_ATTRIBUTES |
| | | | 0x04: RPY_DO_PAYLOAD |
| | | | 0x05: RPY_DO_PARENTS |
| | | | 0x06: RPY_DO_CHILDREN |
| | | | 0x07: RPY_DO_TIMESTAMP |
| | | | 0x08: RPY_NEGATIVE_ACK |

ERR: All unsuccessful message exchanges terminate with an ERR message. All ERR messages include a 1-byte error code followed by an error message (which may be blank).

ERR Header:

| Field | Type | Length | Value | Description |
|---|---|---|---|---|
| ERR_CODE | Integer | 1 | 0-255 | Error Code |
| ERR_MSG | String | Variable | | Error Message |

Error Codes:

| Error | Code | Description |
|---|---|---|
| INVALID_MESSAGE | 0x00 | Message is invalid |
| INVALID_DO_ID | 0x01 | Data Object ID is invalid |
| INVALID_APPLICATION_ID | 0x02 | Application ID is invalid |
| INSUFFICIENT_SEC | 0x03 | Insufficient Security Credentials |
| INSUFFICIENT_RES | 0x04 | Insufficient Resources |
| INVALID_ASSOC | 0x05 | Invalid Association |
| UNKNOWN | 0xFF | General Failure |

### Framework-Oriented Messages

### Connection Status

MSG_AB_CONNECT: This message is sent by the Client to establish application level connection and request authentication. This message is sent by the Client to the Server to establish an application session before any other messages are sent.

| Field | Type | Length | Value | Description |
|---|---|---|---|---|
| MSG_TYPE | Integer | 1 | 0x00 | MSG_AB_CONNECT |
| LOGIN_USER | String | Variable | | User Name |
| LOGIN_PASS | String | Variable | | Password |

MSG_AB_DISCONNECT: This message is sent by the Client to remove an application-level connection between the AppBus server and one application on the Client device.

| Field | Type | Length | Value | Description |
|---|---|---|---|---|
| MSG_TYPE | Integer | 1 | 0x01 | MSG_AB_DISCONNECT |
| APP_CID | Integer | 4 | | Application Context ID |

### Framework-Oriented Messages

### Events

MSG_AB_SUBSCRIBE: This message is sent when a Client application wishes to subscribe to AppBus Data Object insertion events. A subscribed application receives a MSG_AB_NOTIFY message each time a Data Object is added to the AppBus repository.

| Field | Type | Length | Value | Description |
|---|---|---|---|---|
| MSG_TYPE | Integer | 1 | 0x02 | MSG_AB_SUBSCRIBE |
| SECURE_LVL | Integer | 1 | | Indicates section subscribed |
| | | | | to: |
| | | | | 0 = public only |
| | | | | 1 = secure only |
| | | | | 2 = both public and secure |

If the application has validated for secure access, it may indicate its desire to only see Data Object insertion events that occur in the secure portion of the AppBus with the SECURE_ACC indicator. A remote application may want to change the security level of its insertion event notifications during the course of a connected session. If this is the case, the application may change its subscription from secure section events only to secure section events and public section events (or vice versa) by unsubscribing (MSG_AB_UNSUBSCRIBE) and subscribing again with the new parameters.

MSG_AB_UNSUBSCRIBE: This message is sent when a Client application wishes to unsubscribe to Data Object insertion events.

| Field | Type | Length | Value | Description |
|---|---|---|---|---|
| MSG_TYPE | In- | 1 | 0x03 | MSG_AB_UNSUBSCRIBE |
| | teger | | | |
| SECURE_LVL | In- | 1 | | Section unsubscribed from: |
| | teger | | | 0 = public only |
| | | | | 1 = secure only |
| | | | | 2 = both public and secure |

MSG_AB_NOTIFY: This message is sent from the Server to subscribed Client applications to inform the applications of Data Object insertions into the AppBus repository. This message and the other notification messages are the only messages initiated by the server.

| Field | Type | Length | Value | Description |
|---|---|---|---|---|
| MSG_TYPE | Integer | 1 | 0x04 | MSG_AB_NOTIFY |
| TIMESTAMP | Integer | 4 | | Insertion Timestamp |
| DO_ID | Integer | 4 | | Data Object Identifier |
| MOD_APP_ID | Integer | 4 | | Modifying application ID |
| SECURE_FLAG | Integer | 1 | | Indicates secure status of DO: |
| | | | | 0 = public |
| | | | | 1 = secure |
| | | | | 2 = undefined |
| NUM_ATT | Integer | 2 | 0-65535 | Number of attributes passed |
| NUM_CHILDREN | Integer | 2 | 0-65535 | Number of children |
| NUM_PARENTS | Integer | 2 | 0-65535 | Number of parents |

Zero or more copies of the following (as indicated by NUM_ATT):

| | | | | |
|---|---|---|---|---|
| ATT_NAME | String | Variable | | Attribute name |
| ATT_TYPE | Integer | 1 | 0, 1, or 2 | Attribute data type indicator |
| ATT_VALUE | String | Variable | | Attribute value |

Zero or more copies of the following (as indicated by NUM_CHILDREN):

| | | | |
|---|---|---|---|
| DO_ID | Integer | 4 | Child Data Object ID |

Zero or more copies of the following (as indicated by NUM_PARENTS):

| | | | |
|---|---|---|---|
| DO_ID | Integer | 4 | Parent Data Object ID |

This message should have a complete list of the attribute names and corresponding values for the Data Object identified by the DO_ID.

### Framework-Oriented Messages

### Query

MSG_AB_QUERY: This message is sent by the Client to perform a general query for Data Objects that correspond to the match conditions presented in the query message. Queries are defined using supported predicates including both comparison (less than, greater than, equals to, etc.) and logical (and, or, not) operators. Queries can be performed selectively on the public section, on the secure section, or on both together.

| Field | Type | Length | Value | Description |
|---|---|---|---|---|
| MSG_TYPE | Integer | 1 | 0x05 | MSG_AB_QUERY |
| SECURE_ACC | Integer | 1 | 0, 1, or 2 | Secure section access indicator: |
| | | | | 0 = public only |
| | | | | 1 = secure only |
| | | | | 2 = both public and secure |
| QUERY_DATA_LEN | Integer | 2 | 0-65535 | Length of serialized query data |

Query data bytes of total length QUERY_DATA_LEN, formatted as specified above

The query message uses a defined serialization format (see below) to pack predicates into byte-buffers for transmission.
Serialization format is specified for different kinds of predicates. When predicates are nested (e.g., in logical predicate operators), the inner predicates are expanded and packed in a defined order {lhs, rhs}.
For binary comparison predicates (EQUALS, LESS_THAN, LESS_THAN_EQUALS, GREATER_THAN, GREATER_THAN_EQUALS):

Integer PredicateCode (1 byte)

String AttributeName

Integer AttributeTypeCode (1 byte)

String AttributeValue

| Field | Type | Length | Value | Description |
|---|---|---|---|---|
| PREDICATE_CODE | Integer | 1 | 0x00-0x04 | Predicate type |
| | | | | identifier |
| ATT_NAME | String | Variable | | Attribute Name |
| ATT_TYPE | Integer | 1 | 0, 1, or 2 | Attribute Type |
| ATT_VALUE | String | Variable | | Attribute Value |

For unary comparison predicates (ATTRIBUTE_HAS_VALUE):

Integer PredicateCode (1 byte)

String AttributeName

| Field | Type | Length | Value | Description |
|---|---|---|---|---|
| PREDICATE_CODE | Integer | 1 | 0x05 | Predicate type |
| | | | | identifier |
| ATT_NAME | String | Variable | | Attribute Name |

For binary logical predicates (AND, OR):

Integer PredicateCode (1 byte)

Predicate LHS

Predicate RHS

| Field | Type | Length | Value | Description |
|---|---|---|---|---|
| PREDICATE_CODE | Integer | 1 | 0x06-0x07 | Predicate type |
| | | | | identifier |
| PREDICATE_LHS | | Variable | | Nested |
| | | | | predicate |
| PREDICATE_RHS | | Variable | | Nested |
| | | | | predicate |

For unary logical predicates (NOT):

Integer PredicateCode (1 byte)

Predicate LHS

| Field | Type | Length | Value | Description |
|---|---|---|---|---|
| PREDICATE_CODE | Integer | 1 | 0x08 | Predicate type |
| | | | | identifier |
| PREDICATE_LHS | | Variable | | Nested predicate |

AttributeTypeCodes are specified as follows:

0x01 ATTRIBUTE_STRING_VALUE

0x02 ATTRIBUTE_INTEGER_VALUE

0x03 ATTRIBUTE_TIME_VALUE

PredicateCodes are specified as follows:

0x00 PRED_EQUALS

0x01 PRED_LESS_THAN

0x02 PRED_LESS_THAN_EQUALS

0x03 PRED_GREATER_THAN

0x04 PRED_GREATER_THAN_EQUALS

0x05 PRED_ATTRIBUTE_HAS_VALUE

0x06 PRED_AND

0x07 PRED_OR

0x08 PRED_NOT

### Framework-Oriented Messages

### Data Manipulation

MSG_AB_CREATE_DO: This message is sent by the Client to create a new Data Object with a valid identifier. (This process does not add the object to the AppBus.)

| Field | Type | Length | Value | Description |
|---|---|---|---|---|
| MSG_TYPE | Integer | 1 | 0x06 | MSG_AB_CREATE_DO |

MSG_AB_ADD_DO: This message is sent by the Client to add a Data Object to the AppBus.

| Field | Type | Length | Value | Description |
|---|---|---|---|---|
| MSG_TYPE | Integer | 1 | 0x07 | MSG_AB_ADD_DO |
| APP_CID | Integer | 4 | | Application Context ID |
| DO_ID | Integer | 4 | | Data Object Identifier |
| SECURE_ACC | Integer | 1 | | Secure section access |
| | | | | indicator: |
| | | | | 0 = public |
| | | | | 1 = secure |

MSG_AB_REMOVE_REFS: This message is typically sent by the Remote Side Connection or Remote Side Session and not by the application itself. This message is to allow for server-side processes to remove references to unneeded Data Objects.

| Field | Type | Length | Value | Description |
|---|---|---|---|---|
| MSG_TYPE | Integer | 1 | 0x08 | MSG_AB_REMOVE_REFS |
| NUM_ATT | Integer | 2 | 0-65535 | Number of reference IDs |

Zero or more copies of the following (as indicated by NUM_ATT):

| | | | |
|---|---|---|---|
| DO_ID | Integer | 4 | Data Object ID to dereference |

### Single Data-Object-Oriented Messages

### Events

MSG_DO_SUBSCRIBE: This message is sent when the Client wishes to subscribe to data change events from a specific Data Object. A subscribed application will receive a MSG_DO_NOTIFY message each time that the observed Data Object is modified in some way.

| Field | Type | Length | Value | Description |
|---|---|---|---|---|
| MSG_TYPE | Integer | 1 | 0x09 | MSG_DO_SUBSCRIBE |
| DO_ID | Integer | 4 | | Observed Data Object |

MSG_DO_UNSUBSCRIBE: This message is sent when a Client application wishes to no longer receive notifications with respect to updates from a particular Data Object.

| Field | Type | Length | Value | Description |
|---|---|---|---|---|
| MSG_TYPE | Integer | 1 | 0x0A | MSG_DO_UNSUBSCRIBE |
| DO_ID | Integer | 4 | | Observed Data Object |

MSG_DO_NOTIFY_UPD_ATT: This message is sent from the Server to the Client to inform of changes to an attribute in a particular Data Object. This message and the other notification messages are the only messages initiated by the Server. (See MSG_DO_NOTIFY_UPD_TSTAMP for a related notification message.)

| Field | Type | Length | Value | Description |
|---|---|---|---|---|
| MSG_TYPE | Integer | 1 | 0x0B | MSG_DO_NOTIFY_UPD_ATT |
| TIMESTAMP | Integer | 4 | | Update Timestamp |
| DO_ID | Integer | 4 | | Data Object Identifier |
| MOD_APP_ID | Integer | 4 | | Modifying application ID |
| ATT_NAME | String | Variable | | Modified attribute name |
| ATT_TYPE | Integer | 1 | 0, 1, or 2 | Attribute data type indicator |
| ATT_VALUE | String | Variable | | Modified attribute value |

The MOD_APP_ID indicates which application performed the Data Object mutation.

MSG_DO_NOTIFY_UPD_PAY: This message is sent from the Server to the Client to inform of changes to the payload of a particular Data Object.

| Field | Type | Length | Value | Description |
|---|---|---|---|---|
| MSG_TYPE | Integer | 1 | 0x0C | MSG_DO_NOTIFY_UPD_PAY |
| TIMESTAMP | Integer | 4 | | Update Timestamp |
| DO_ID | Integer | 4 | | Data Object Identifier |
| MOD_APP_ID | Integer | 4 | | Modifying application ID |

MSG_DO_NOTIFY_UPD_TSTAMP: This message is sent from the server to the client to notify it of timestamp updates to one or more data objects. The message is used in two cases.
To provide notifications in response to an explicit setTimestamp( ) invocation made on the specified data object and
To provide timestamp update information for associated parents/children of a data object whose timestamp was modified (either explicitly, or implicitly by a setAttribute( ) invocation). This information is used only for updating timestamps at the client (to maintain consistency) and will not cause notifications to be delivered to subscribers of these associated objects.
   Note: A setAttribute( ) invocation will generate a MSG_DO NOTIFY_UPD_ATT notification by default. In that context, this will be a second notification message triggered by the same update event. In order to ensure better consistency at the client, this notification should be delivered ahead of the attribute update notification.

| Field | Type | Length | Value | Description |
|---|---|---|---|---|
| MSG_TYPE | Integer | 1 | 0x0D | MSG_DO_NOTIFY_UPD_TSTAMP |
| NUM_NOTIFY | Integer | 2 | | Number of notification triples |
| NUM_NON_NOTIFY | Integer | 2 | | Number of non-notification pairs |

Zero or more copies of the following (as indicated by NUM_NOTIFY):

| | | | |
|---|---|---|---|
| DO_ID | Integer | 4 | Data Object Identifier |
| MOD_APP_ID | Integer | 4 | Modifying application ID |
| TIMESTAMP | Integer | 4 | Update Timestamp |

Zero or more copies of the following (as indicated by NUM_NON_NOTIFY):

| | | | |
|---|---|---|---|
| DO_ID | Integer | 4 | Data Object Identifier |
| TIMESTAMP | Integer | 4 | Update Timestamp |

MSG_DO_NOTIFY_ADD_CHILD: This message is sent from the server to the client to inform of changes to the children of a particular Data Object.

| Field | Type | Length | Value | Description |
|---|---|---|---|---|
| MSG_TYPE | Integer | 1 | 0x0E | MSG_DO_NOTIFY_ADD_CHILD |
| DO_ID | Integer | 4 | | Data Object Identifier (parent) |
| TIMESTAMP | Integer | 4 | | Parent Timestamp |
| DO_ID | Integer | 4 | | Data Object Identifier (child) |
| TIMESTAMP | Integer | 4 | | Child Timestamp |
| MOD_APP_ID | Integer | 4 | | Modifying application ID |

MSG_DO_NOTIFY_ADD_PARENT: This message is sent from the server to the client to inform of changes to the parents of a particular Data Object.

| Field | Type | Length | Value | Description |
|---|---|---|---|---|
| MSG_TYPE | Integer | 1 | 0x0F | MSG_DO_NOTIFY_ADD_PARENT |
| DO_ID | Integer | 4 | | Data Object Identifier (child) |
| TIMESTAMP | Integer | 4 | | Child Timestamp |
| DO_ID | Integer | 4 | | Data Object Identifier (parent) |
| TIMESTAMP | Integer | 4 | | Parent Timestamp |
| MOD_APP_ID | Integer | 4 | | Modifying application ID |

MSG_DO_NOTIFY_REM_ATT: This message is sent from the Server to the Client to inform of removal of an attribute in a particular Data Object.

| Field | Type | Length | Value | Description |
|---|---|---|---|---|
| MSG_TYPE | Integer | 1 | 0x10 | MSG_DO_NOTIFY_REM_ATT |
| TIMESTAMP | Integer | 4 | | Update Timestamp |
| DO_ID | Integer | 4 | | Data Object Identifier |
| MOD_APP_ID | Integer | 4 | | Modifying application ID |
| ATT_NAME | String | Variable | | Modified attribute name |

MSG_DO_NOTIFY_REM_PAY: This message is sent from the Server to the Client to inform of removal of the payload of a particular Data Object.

| Field | Type | Length | Value | Description |
|---|---|---|---|---|
| MSG_TYPE | Integer | 1 | 0x11 | MSG_DO_NOTIFY_REM_PAY |
| TIMESTAMP | Integer | 4 | | Update Timestamp |
| DO_ID | Integer | 4 | | Data Object Identifier |
| MOD_APP_ID | Integer | 4 | | Modifying application ID |

MSG_DO_NOTIFY_REM_CHILD: This message is sent from the server to the client to inform of changes to the children of a particular Data Object.

| Field | Type | Length | Value | Description |
|---|---|---|---|---|
| MSG_TYPE | Integer | 1 | 0x12 | MSG_DO_NOTIFY_REM_CHILD |
| TIMESTAMP | Integer | 4 | | Update Timestamp |
| DO_ID | Integer | 4 | | Data Object Identifier (parent) |
| DO_ID | Integer | 4 | | Data Object Identifier (child) |
| MOD_APP_ID | Integer | 4 | | Modifying application ID |

MSG_DO NOTIFY_REM_PARENT: This message is sent from the server to the client to inform of changes to the parents of a particular Data Object.

| Field | Type | Length | Value | Description |
|---|---|---|---|---|
| MSG_TYPE | Integer | 1 | 0x13 | MSG_DO_NOTIFY_REM_PARENT |
| TIMESTAMP | Integer | 4 | | Update Timestamp |
| DO_ID | Integer | 4 | | Data Object Identifier (child) |
| DO_ID | Integer | 4 | | Data Object Identifier (parent) |
| MOD_APP_ID | Integer | 4 | | Modifying application ID |

MSG_DO_NOTIFY_ATTACHED: This message is sent from the server to the client to inform of changes to the status of Framework attachment of a particular Data Object.

| Field | Type | Length | Value | Description |
|---|---|---|---|---|
| MSG_TYPE | Integer | 1 | 0x14 | MSG_DO_NOTIFY_ATTACHED |
| TIMESTAMP | Integer | 4 | | Update Timestamp |
| DO_ID | Integer | 4 | | Data Object Identifier |
| ATTACH_FLAG | Boolean | 1 | | Attachment status |

### Single Data-Object-Oriented Messages

### Query

MSG_DO_REQ_ATTRIBUTES: This message is sent by the Client to request the values of specific attributes contained in a particular Data Object. A value of zero for NUM_ATT indicates that no specific attribute names will be listed in the message and that the request is for all of the attributes in the specified Data Object.

| Field | Type | Length | Value | Description |
|---|---|---|---|---|
| MSG_TYPE | Integer | 1 | 0x15 | MSG_DO_REQ_ATTRIBUTES |
| DO_ID | Integer | 4 | | Data Object Identifier |
| NUM_ATT | Integer | 2 | 0-65535 | Number of attributes requested |

Zero or more copies of the following (as indicated by NUM_ATT):

| | | | |
|---|---|---|---|
| ATT_NAME | String | Variable | Attribute name |

MSG_DO_REQ_PAYLOAD: This message is sent by the Client to request the value of the payload contained in a particular Data Object.

| Field | Type | Length | Value | Description |
|---|---|---|---|---|
| MSG_TYPE | Inte- | 1 | 0x16 | MSG_DO_REQ_PAYLOAD |
| | ger | | | |
| DO_ID | Inte- | 4 | | Data Object Identifier |
| | ger | | | |

If the application has validated for secure access, it may indicate its desire to only see matches with Data Objects that reside in the secure portion of the AppBus. This is accomplished by setting the SECURE_ACC indicator to TRUE.

MSG_DO_REQ_GET_PARENTS: This message is sent by the Client to perform a specialized query on the specified data object. By passing a template Data Object ID, the Client will receive back a list of Data Object IDs that are direct parents of the specified data object. By default, these will be objects that reside in the same section (secure or public) of the AppBus as the specified data object.

| Field | Type | Length | Value | Description |
|---|---|---|---|---|
| MSG_TYPE | Integer | 1 | 0x17 | MSG_DO_REQ_GET_PARENTS |
| DO_ID | Integer | 4 | | Template Data Object ID |

If the application has validated for secure access, it may indicate its desire to only see matches with Data Objects that reside in the secure portion of the AppBus. This is accomplished by setting the SECURE_ACC indicator to TRUE.

MSG_DO_REQ_GET_CHILDREN: This message is sent by the Client to perform a specialized query on the specified data object. By passing a template Data Object ID, the Client will receive back a list of Data Object IDs that are direct children of the specified data object. By default, these will be objects that reside in the same section (secure or public) of the AppBus as the specified data object.

| Field | Type | Length | Value | Description |
|---|---|---|---|---|
| MSG_TYPE | Inte- | 1 | 0x18 | MSG_AB_GET_CHILDREN |
| | ger | | | |
| DO_ID | Inte- | 4 | | Template Data Object ID |
| | ger | | | |

If the application has validated for secure access, it may indicate its desire to only see matches with Data Objects that reside in the secure portion of the AppBus. This is accomplished by setting the SECURE_ACC indicator to TRUE.

### Single Data-Object-Oriented Messages

### Data Manipulation

MSG_DO_UPDATE_ATTRIBUTES: This message is sent by a Client application to modify an attribute of a Data Object that exists on the Server.

| Field | Type | Length | Value | Description |
|---|---|---|---|---|
| MSG_TYPE | Integer | 1 | 0x19 | MSG_DO_UPDATE_ATTRIBUTES |
| APP_CID | Integer | 4 | | Application Context ID |
| DO_ID | Integer | 4 | | Data Object Identifier |
| NUM_ATT | Integer | 2 | 0-65535 | Number of attributes |

Zero or more copies of the following (as indicated by NUM_ATT):

| | | | | |
|---|---|---|---|---|
| ATT_NAME | String | Variable | | Attribute name |
| ATT_TYPE | Integer | 1 | 0, 1, or 2 | Attribute data type indicator |
| ATT_VALUE | String | Variable | | Attribute value |

MSG_DO_UPDATE_PAYLOAD: This message is sent by a Client application to modify the payload of a Data Object that exists on the Server.

| Field | Type | Length | Value | Description |
|---|---|---|---|---|
| MSG_TYPE | Integer | 1 | 0x1A | MSG_DO_UPDATE_PAYLOAD |
| APP_CID | Integer | 4 | | Application Context ID |
| DO_ID | Integer | 4 | | Data Object Identifier |
| PAYLOAD_TYPE | String | Variable | | MIME type of Payload |
| PAYLOAD_LEN | Integer | 4 | 0-232 | Size of Payload |
| PAYLOAD | bytes | Variable | | Payload value |

MSG_DO_UPDATE_TIMESTAMP: This message is sent by a Client application to modify the timestamp of a Data Object that exists on the Server.

| Field | Type | Length | Value | Description |
|---|---|---|---|---|
| MSG_TYPE | Integer | 1 | 0x1B | MSG_DO_UPDATE_TIMESTAMP |
| APP_CID | Integer | 4 | | Application Context ID |
| DO_ID | Integer | 4 | | Data Object Identifier |

MSG_DO_ADD_CHILD: This message is sent by the Client to request that a parent-child association be established between the two data objects specified.

| Field | Type | Length | Value | Description |
|---|---|---|---|---|
| MSG_TYPE | Integer | 1 | 0x1C | MSG_DO_REQ_ADD_CHILD |
| APP_CID | Integer | 4 | | Application Context ID |
| DO_ID | Integer | 4 | | Data Object Identifier (parent) |
| DO_ID | Integer | 4 | | Data Object Identifier (child) |

MSG_DO_REMOVE_ATTRIBUTES: This message is sent by a Client application to remove an attribute from a Data Object that exists on the Server. This message is sent by a Client application to remove with a single message multiple attributes from a Data Object that exists on the Server.

| Field | Type | Length | Value | Description |
|---|---|---|---|---|
| MSG_TYPE | Integer | 1 | 0x1D | MSG_DO_REMOVE_ATTRIBUTES |
| APP_CID | Integer | 4 | | Application Context ID |
| DO_ID | Integer | 4 | | Data Object Identifier |
| NUM_ATT | Integer | 2 | 0-65535 | Number of attributes |

Zero or more copies of the following (as indicated by NUM_ATT):

| | | | |
|---|---|---|---|
| ATT_NAME | String | Variable | Attribute name |

MSG_DO_REMOVE_PAYLOAD: This message is sent by a Client application to remove the payload from a Data Object that exists on the Server.

| Field | Type | Length | Value | Description |
|---|---|---|---|---|
| MSG_TYPE | Integer | 1 | 0x1E | MSG_DO_REMOVE_PAYLOAD |
| APP_CID | Integer | 4 | | Application Context ID |
| DO_ID | Integer | 4 | | Data Object Identifier |

MSG_DO_REMOVE_CHILDREN: This message is sent by a Client application to disassociate selected children from a parent Data Object.

| Field | Type | Length | Value | Description |
|---|---|---|---|---|
| MSG_TYPE | Integer | 1 | 0x1F | MSG_DO_REMOVE_CHILDREN |
| APP_CID | Integer | 4 | | Application Context ID |
| DO_ID | Integer | 4 | | Parent children are removed from |
| NUM_ID | Integer | 2 | | Number of children to remove |

Zero or more copies of the following (as indicated by NUM_ID):

| | | | |
|---|---|---|---|
| DO_ID | Integer | 4 | Data Object Identifier (child) |

MSG_DO_REMOVE ALL_CHILDREN: This message is sent by a Client application to disassociate all children from a parent Data Object.

| Field | Type | Length | Value | Description |
|---|---|---|---|---|
| MSG_TYPE | Integer | 1 | 0x20 | MSG_DO_REMOVE_ALL_CHILDREN |
| APP_CID | Integer | 4 | | Application Context ID |
| DO_ID | Integer | 4 | | Parent children are removed from |

### Replies

RPY_POSITIVE_ACK: This reply is sent by the Server side or the Client side to indicate a positive acknowledgement of an action message that does not involve returning any data.

| Field | Type | Length | Value | Description |
|---|---|---|---|---|
| RPY_TYPE | Integer | 1 | 0x00 | RPY_POSITIVE_ACK |

RPY_NEGATIVE_ACK: This reply is sent by the Server side or the Client side to indicate a negative outcome in an action message that returns a true/false result. A “true” result is indicated by sending a RPY_POSITIVE_ACK, while, “false” is indicated by sending RPY_NEGATIVE_ACK. (Note that this response does NOT indicate error: Any explicit errors will trigger their own ERR messages. Thus, the client can expect to receive either RPY or ERR, not both.)

| Field | Type | Length | Value | Description |
|---|---|---|---|---|
| RPY_TYPE | Integer | 1 | 0x08 | RPY_NEGATIVE_ACK |

RPY_APP_CONNECTION_CRED: This reply is sent by the Server to the Client in response to a MSG_AB_CONNECT message. This response is how the Client side establishes the Application Context ID for a particular Client side application.

| Field | Type | Length | Value | Description |
|---|---|---|---|---|
| RPY_TYPE | Integer | 1 | 0x01 | RPY_APP_CONNECTION_CRED |
| APP_CID | Integer | 4 | | Application Context ID |
| SECURITY | Integer | 1 | | Indicates protected validation |

### Data Replies

RPY_DO_ID_LIST: This reply is sent in response to several messages, both queries and actions, where the client receives back information about which Data Objects were affected.

| Field | Type | Length | Value | Description |
|---|---|---|---|---|
| RPY_TYPE | Integer | 1 | 0x02 | RPY_DO_ID_LIST |
| NUM_OPEN | Integer | 2 | 0-65535 | Number of Open IDs |
| | | | | returned |
| NUM_SEC | Integer | 2 | 0-65535 | Number of Secure IDs |
| | | | | returned |

Zero or more copies of the following (as indicated by NUM_OPEN):

| | | | |
|---|---|---|---|
| DO_ID | Integer | 4 | Data Object Identifier |
| TIMESTAMP | Integer | 4 | Current timestamp |

Zero or more copies of the following (as indicated by NUM_SEC):

| | | | |
|---|---|---|---|
| DO_ID | Integer | 4 | Data Object Identifier |
| TIMESTAMP | Integer | 4 | Current timestamp |

If this reply is sent in response to MSG_AB_ADD_DO, then NUM_ID should equal 1. RPY_DO_ATTRIBUTES: This reply is sent from the Server to the Client in response to a MSG_DO_REQ_ATTRIBUTES and provides a list of attribute names and their corresponding values.

| Field | Type | Length | Value | Description |
|---|---|---|---|---|
| RPY_TYPE | Integer | 1 | 0x03 | RPY_DO_ATTRIBUTES |
| TIMESTAMP | Integer | 4 | | Current timestamp |
| DO_ID | Integer | 4 | | Data Object Identifier |
| NUM_ATT | Integer | 2 | 0-65535 | Number of attributes |
| | | | | returned |

Zero or more copies of the following (as indicated by NUM_ATT):

| | | | | |
|---|---|---|---|---|
| ATT_NAME | String | Vari- | | Attribute name |
| | | able | | |
| ATT_TYPE | Integer | 1 | 0, 1, | Attribute data type indicator |
| | | | or 2 | |
| ATT_VALUE | String | Vari- | | Attribute value |
| | | able | | |

RPY_DO_PAYLOAD: This reply is sent from the Server to the Client in response to a MSG_DO_REQ_PAYLOAD and provides the value of the payload for a given Data Object.

| Field | Type | Length | Value | Description |
|---|---|---|---|---|
| RPY_TYPE | Integer | 1 | 0x04 | RPY_DO_PAYLOAD |
| TIMESTAMP | Integer | 4 | | Current timestamp |
| DO_ID | Integer | 4 | | Data Object Identifier |
| PAYLOAD_TYPE | String | Vari- | | MIME type of Payload |
| | | able | | |
| PAYLOAD_LEN | Integer | 4 | 0-232 | Size of Payload |
| PAYLOAD | bytes | Vari- | | Payload value |
| | | able | | |

RPY_DO_PARENTS: This reply is sent in response to a query to determine parents for the specified data object.

| Field | Type | Length | Value | Description |
|---|---|---|---|---|
| RPY_TYPE | Integer | 1 | 0x05 | RPY_DO_ID_LIST |
| TIMESTAMP | Integer | 4 | | Current timestamp |
| DO_ID | Integer | 4 | | Data Object Identifier |
| NUM_ID | Integer | 2 | 0-65535 | Number of IDs returned |

Zero or more copies of the following (as indicated by NUM_ID):

| | | | |
|---|---|---|---|
| DO_ID | Integer | 4 | Data Object Identifier |
| TIMESTAMP | Integer | 4 | Current timestamp |

RPY_DO_CHILDREN: This reply is sent in response to a query to determine children for the specified data object.

| Field | Type | Length | Value | Description |
|---|---|---|---|---|
| RPY_TYPE | Integer | 1 | 0x06 | RPY_DO_ID_LIST |
| TIMESTAMP | Integer | 4 | | Current timestamp |
| DO_ID | Integer | 4 | | Data Object Identifier |
| NUM_ID | Integer | 2 | 0-65535 | Number of IDs returned |

Zero or more copies of the following (as indicated by NUM_ID):

| | | | |
|---|---|---|---|
| DO_ID | Integer | 4 | Data Object Identifier |
| TIMESTAMP | Integer | 4 | Current timestamp |

RPY_DO_TIMESTAMP: This reply is sent in response to a query to determine a timestamp for the specified data object.

| Field | Type | Length | Value | Description |
|---|---|---|---|---|
| RPY_TYPE | Integer | 1 | 0x07 | RPY_DO_TIMESTAMP |
| TIMESTAMP | Integer | 4 | | Updated Timestamp |
| DO_ID | Integer | 4 | | Data Object Identifier |

### Valid Message/Reply Combinations

The following is a list of valid Message/Reply combinations. Various Error responses, such as INVALID_MESSAGE and UNKNOWN are applicable to nearly all messages and therefore are not enumerated here. As such any message initiator should be ready to receive these error responses at any time. More specific error messages that apply in certain circumstances are listed where they apply. Note that an incorrectly formulated query will also result in the receipt of an INVALID_MESSAGE.

| Message | Valid Replies |
|---|---|
| MSG_AB_CONNECT | RPY_APP_CONNECTION_CRED |
| | ERROR: INSUFFICIENT_SEC |
| MSG_AB_DISCONNECT | RPY_POSITIVE_ACK |
| MSG_AB_SUBSCRIBE | RPY_POSITIVE_ACK |
| | RPY_NEGATIVE_ACK |
| | ERROR: INSUFFICIENT_SEC |
| MSG_AB_UNSUBSCRIBE | RPY_POSITIVE_ACK |
| | RPY_NEGATIVE_ACK |
| MSG_AB_NOTIFY | |
| MSG_AB_QUERY | RPY_DO_ID_LIST |
| MSG_AB_CREATE_DO | RPY_DO_ID_LIST |
| MSG_AB_ADD_DO | RPY_POSITIVE_ACK |
| | RPY_NEGATIVE_ACK |
| | ERROR: INSUFFICIENT_SEC |
| | ERROR: INSUFFICIENT_RES |
| MSG_AB_REMOVE_REFS | RPY_POSITIVE_ACK |
| MSG_DO_SUBSCRIBE | RPY_POSITIVE_ACK |
| | RPY_NEGATIVE_ACK |
| | ERROR: INSUFFICIENT_SEC |
| MSG_DO_UNSUBSCRIBE | RPY_POSITIVE_ACK |
| | RPY_NEGATIVE_ACK |
| MSG_DO_NOTIFY_UPD_ATT | |
| MSG_DO_NOTIFY_UPD_PAY | |
| MSG_DO_NOTIFY_UPD_TSTAMP | |
| MSG_DO_NOTIFY_ADD_CHILD | |
| MSG_DO_NOTIFY_ADD_PARENT | |
| MSG_DO_NOTIFY_REM_ATT | |
| MSG_DO_NOTIFY_REM_PAY | |
| MSG_DO_NOTIFY_REM_CHILD | |
| MSG_DO_NOTIFY_REM_PARENT | |
| MSG_DO_NOTIFY_ATTACHED | |
| MSG_DO_REQ_ATTRIBUTES | RPY_DO_ATTRIBUTES |
| MSG_DO_REQ_PAYLOAD | RPY_DO_PAYLOAD |
| MSG_DO_REQ_GET_PARENTS | RPY_DO_PARENTS |
| MSG_DO_REQ_GET_CHILDREN | RPY_DO_CHILDREN |
| MSG_DO_UPDATE_ATTRIBUTES | RPY_POSITIVE_ACK |
| | RPY_NEGATIVE_ACK |
| MSG_DO_UPDATE_PAYLOAD | RPY_POSITIVE_ACK |
| MSG_DO_UPDATE_TIMESTAMP | RPY_DO_TIMESTAMP |
| MSG_DO_ADD_CHILD | RPY_POSITIVE_ACK |
| | RPY_NEGATIVE_ACK |
| | ERROR: INVALID_ASSOC |
| MSG_DO_REMOVE_ATTRIBUTES | RPY_POSITIVE_ACK |
| | RPY_NEGATIVE_ACK |
| MSG_DO_REMOVE_PAYLOAD | RPY_POSITIVE_ACK |
| MSG_DO_REMOVE_CHILDREN | RPY_POSITIVE_ACK |
| | RPY_NEGATIVE_ACK |
| MSG_DO_REMOVE_ALL_CHILDREN | RPY_POSITIVE_ACK |

### Client-Side Data Management

Data Object Reference Flushing: Due to the fact that the server side (Remote Sessions Handler) is required to retain references to Data Objects accessed by the Remote Sessions, the client side is required to notify the server side when these references are no longer required in order that the server side may clean up unneeded references and allow for garbage collection by the VM.

Data Object Payload Caching: To reduce over-the-air bandwidth usage, the Client and Server sides may agree to do deferred fulfillment of Data Object payload data when the payload would normally be updated by a MSG_DO_NOTIFY_PAYLOAD. If deferment has been agreed to, the INVAL_ONLY may be set in the message indicating an invalidation of the payload value but not providing the new one. The new value would then be requested by the Client as needed using a MSG_DO_REQ_PAYLOAD. Note that the Server is not obligated to do this and may in fact include the payload value in the MSG_DO_NOTIFY_PAYLOAD message. Therefore, the client should be ready to handle this at any time.

Data Object Reference Management: One suggested method for determining when client-side references are no longer needed is Weak References. When the reference is garbage collected on the client side, the Weak Reference goes to null, and a message is sent across the Remote link to allow the server to remove its held reference to the corresponding Data Object

### Server-Side Data Management

Data Object Reference Holding: The AppBus is a dynamic data buffering system. Its very nature (access to most recently used data and events) means that Data Objects will be available on the bus for an indeterminate amount of time. Additionally, once these Data Objects are no longer referenced by the AppBus framework nor by any applications, they may be garbage collected by the VM. Consequently, in order to emulate the kind of data availability and retention that a local application might have, the Remote Sessions Handler needs to retain references to accessed Data Objects until the Remote Session has indicated that they are no longer needed. (A local application would receive a list of Data Object references in a AppBus query, and as long as it retained the references, the objects would be guaranteed not to be garbage collected, but not guaranteed to remain indexed by the AppBus.) Consequently, the Remote Session has the responsibility of notifying the Remote Sessions Handler of unneeded references.

Event Subscription: Since standard method/object callback mechanisms do not function across the remote access link, a translation system is necessary to handle event subscription notifications. When a remote application chooses to receive Data Object update notifications, it creates and transmits a MSG_AB_SUBSCRIBE message for all Data Object insertion notifications or a MSG_DO_SUBSCRIBE message for individual Data Object notifications. The Remote Proxy/AppBus Session objects are responsible for AppBus event callback registration on behalf of the remote application, keeping a record of the remote application interested in the callback and transmitting the callback events to the remote application using a MSG_AB_NOTIFY message or a MSG_DO_NOTIFY message.

Event Subscription Architectures: Since the Remote Sessions Handler is responsible for event registration and transmission, an indexing/translation structure may be required. Different types of architectures may be used for this. Two possibilities are as follows:
Separate event notification request storage for each Remote Session. Advantage: minimal cleanup for garbage-collected Data Objects, no indexing table required to track which applications are registered for which events. Disadvantage: multiple remote applications residing on the same device registered for the same messages cause multiple messages across the remote link for a given update event.
Pooled event notification request storage. Advantage: messages across remote link minimized by sending each event once that covers all remote applications on the same device. Disadvantage: more recording keeping overhead, such as Weak References to track when Data Objects are garbage collected.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. In a computing environment comprising a server and a plurality of clients, a method for a client to enforce consistency among shared copies of a data element, the method comprising:
sending to the server a request to subscribe to an aspect of the data element;
in response to the subscription request, receiving from the server a first actual value of the subscribed aspect of the data element;
sending to the server a request to update the subscribed aspect of the data element to a requested value; and
in response to the update request, receiving from the server a second actual value of the subscribed aspect of the data element.

2. The method of claim 1 wherein the client is selected from the group consisting of:
an application program, a utility program, and an operating system.

3. The method of claim 1 wherein one computing device hosts both the client and the server, the client and the server not sharing an address space.

4. The method of claim 1 wherein the subscribed aspect of the data element is selected from the group consisting of: an attribute of the data element, a payload of the data element, as association of the data element, and the entire data element.

5. The method of claim 1 further comprising:
in response to the subscription request, receiving from the server actual values for the entire data element.

6. The method of claim 1 further comprising:
in response to the update request, receiving from the server a timestamp indicating when the subscribed aspect of the data element was updated to the second actual value.

7. The method of claim 1 further comprising:
in response to the update request, receiving from the server an identification of a client that most recently updated the subscribed aspect of the data element.

8. In a computing environment comprising a server and a plurality of clients, a method for a client to attempt to lock an aspect of a shared data element, the method comprising:
sending to the server a request to subscribe to the aspect of the data element;
in response to the subscription request, receiving from the server an actual value of the subscribed aspect of the data element;
sending to the server a request to update a lock attribute associated with the subscribed aspect of the data element to LOCKED;
in response to the LOCK request, receiving from the server an actual value of the lock attribute; and
in response to the LOCK request, receiving from the server an identification of a client that most recently updated the lock attribute;
wherein if the received actual value of the lock attribute is LOCKED, and if the lock attribute was most recently updated by the client, then the LOCK request succeeded, else the LOCK request failed.

9. The method of claim 8 wherein the client is selected from the group consisting of:
an application program, a utility program, and an operating system.

10. The method of claim 8 wherein one computing device hosts both the client and the server, the client and the server not sharing an address space.

11. The method of claim 8 wherein the subscribed aspect of the data element is selected from the group consisting of: an attribute of the data element, a payload of the data element, as association of the data element, and the entire data element.

12. The method of claim 8 further comprising:
in response to the subscription request, receiving from the server actual values for the entire data element.

13. The method of claim 8 further comprising:
before sending the LOCK request, sending to the server a request for an actual value of the lock attribute;
in response to the lock-attribute-value request, receiving from the server the actual value of the lock attribute; and
waiting to send the LOCK request until the actual value of the lock attribute is UNLOCKED.

14. In a computing environment comprising a server and a plurality of clients, a method for the server to enforce consistency among shared copies of a data element, the method comprising:
receiving from a first client a first request to subscribe to an aspect of the data element;
in response to the first subscription request, sending to the first client a first actual value of the subscribed aspect of the data element;
receiving from a second client a second request to subscribe to the aspect of the data element;
in response to the second subscription request, sending to the second client a second actual value of the subscribed aspect of the data element;
receiving from the first client a first request to update the subscribed aspect of the data element to a first requested value;
after receiving the first update request, receiving from the second client a second request to update the subscribed aspect of the data element to a second requested value; and
in response to the second update request, sending to the first and second clients an indication that the subscribed aspect of the data element has been updated to the second requested value.

15. The method of claim 14 wherein one computing device hosts both the first client and the server, the first client and the server not sharing an address space.

16. The method of claim 14 wherein the subscribed aspect of the data element is selected from the group consisting of: an attribute of the data element, a payload of the data element, as association of the data element, and the entire data element.

17. The method of claim 14 further comprising:
in response to the first subscription request, sending to the first client actual values for the entire data element.

18. The method of claim 14 further comprising:
in response to the second update request, sending to the first and second clients a timestamp indicating when the subscribed aspect of the data element was updated to the second requested value.

19. The method of claim 14 further comprising:
in response to the second update request, sending to the first and second clients an indication that the second client most recently updated the subscribed aspect of the data element.

20. The method of claim 14 further comprising:
before sending the second-requested-value indication, in response to the first update request, sending to the first and second clients an indication that the subscribed aspect of the data element has been updated to the first requested value.

21. The method of claim 14 further comprising:
tracking clients subscribed to any aspect of the data element; and
deleting the data element when no clients are subscribed to any aspect of the data element.

22. The method of claim 14 further comprising:
receiving from a third client a request to subscribe to the data element; and
when any aspect of the data element is updated, sending to the third client a timestamp.
